(19) United States
(12) Patent Application Publication
(10) Pub. No.: US 2008/0052814 A1
(43) Pub. Date: Mar. 6, 2008

(54) Multi-function assist device

(76) Inventor: Simon Erv Kaiwai, Trinidad, CA (US)

Correspondence Address: MOAZZAM & ASSOCIATES, LLC, 7601 LEWINSVILLE ROAD, SUITE 304, MCLEAN, VA, 22102, US

(21) Appl. No.: 11/513,128

(22) Filed: Aug. 31, 2006

(51) Int. Cl. A61G 7/02; A47K 11/06

(52) U.S. Cl. 4/480

(57) ABSTRACT

Devices and assemblies are disclosed for reducing the number of transfers required for bathroom related activities including in home transport, showering, and toileting by use of attachment rails that permit sliding above bath tub and shower stall threshold barriers.

### BACKGROUND OF THE INVENTION

1. Field of the Invention

The present invention relates to a multi-function assist device for transferring and supporting persons with limited mobility. More particularly, the present invention relates to a pivoting device that can connect to a wheeled base for transfer and a stationary base suitable for use in a shower or bathtub.

2. Background of the Invention

As the American population ages, an increasing number of people face the challenges presented by limited mobility. The elderly, as well as those with injuries, disabilities, and debilitating diseases, often need assistance to accomplish the most basic and personal tasks. Inpatient care can be prohibitively expensive, and patients often have little independence or privacy in an inpatient facility. A significant number of people with physical limitations are instead cared for by loved ones or by professionals within private homes.

Safely caring for persons who lack the physical ability to support or maneuver themselves in home or elsewhere presents a challenge for caretakers. Of particular concern here is the movement of patients with significant physical limitations to allow access to showering and toilet facilities.

Available products may alleviate the problem of supporting a person in these circumstances, but utilizing some of these devices requires moving the patient multiple times. This can easily result in injury. Should the caretaker at any point lose control of the patient, falls resulting in broken bones and other serious injuries may occur. Additionally, handling patients repeatedly with the force necessary to lift or move them may cause bruising and discomfort, particularly in those patients whose conditions render them especially frail. Other products may eliminate the need to move the patient multiple times, but do not provide the convenience of mobility.

An otherwise routine task, such as bathing, for example, presents greater demands than simply moving the patient. Patients unable to fully support themselves must have stable support both during and after the transfer into the bath or shower. But once inside the shower, a patient must have not only support, but also mobility. Thorough bathing, particularly in a shower, is difficult if undertaken from a fixed angle. Conventional chairs, while providing adequate support, make bathing more difficult because they limit mobility. For some patients, increased mobility combined with sufficient support may enable them to bathe in relative privacy with little aid from a caretaker. For those patients who do require assistance from a caretaker, the lack of mobility can present an even greater problem. There is no easy way for a caretaker to bathe a patient sitting in a fixed chair when access to the chair is limited on three sides by the walls of a shower or bathtub.

Furthermore, many of the conventional products on the market present significant obstacles to use of a bathroom by those not in need of assistance. Many devices attach to the bath or shower in such a way that it is difficult or impossible to remove them so that others can use the full space of the shower or bath. Other devices are large or bulky, making repeated removal and replacement an inconvenience. This is true not only of bathing aids, but of many toilet chairs or supports as well.

Other problems arise with providing toilet access. There are currently many devices available on the market to aid those with physical limitations in the use of a conventional toilet. Stationary toilet chairs may provide much-needed support, but they do not address the difficulty of transferring the patient from another supportive device, such as a wheelchair, onto the commode chair. Nor do they address situations where a patients difficulties with communication or bodily control make use of a conventional toilet impractical.

Finally, the purchase, use, and storage of many different pieces of equipment for adapting bathrooms for an in-home patient result in clutter and expense. Furthermore, moving multiple pieces from one bathroom to another is inconvenient and time-consuming, making the thought of travel disheartening.

Thus, there is a need for products that address the tasks of transport, bathing, and toilet use in a way that allows greater mobility and independence. Ideally, these products will be adaptable to a variety of living situations, including situations where the patient shares facilities with other members of the family. To reduce cost, storage space, and complexity, a need for simplicity calls for multi-functional devices that provide continuous support, convenient mobility, and transportability.

### SUMMARY OF THE INVENTION

To make conventional bathrooms suitable for their use, patients with physical limitations need devices providing both support and mobility. The present invention proposes a multi-function device, in the form of a chair assembly, comprised of a collapsible chair which can be mounted on a swivel platform designed to slide between multiple functional bases, including a rolling wheelchair base and a base which can be placed in a shower or bathtub for support of persons while bathing. The bases are connectable to allow the chair, mounted on the platform, to be moved easily between the wheelchair base and the shower or bathtub base, providing an easy, safe, and comfortable transition for the patient. The swivel design maximizes mobility, facilitating thorough bathing. The chair may also include a removable commode to prevent the necessity of moving a patient onto and off of a standard toilet.

In one exemplary embodiment, the present invention is a chair. The chair includes a chair frame and seat that is attached to a swiveling platform. The platform sits in a wheeled base and is suitable for use as a transfer chair. The wheeled can connect to a second, stationary base which may be placed in a conventional shower stall, and the platform can slide between the bases so that the chair can serve as a support chair for showering.

In another exemplary embodiment, the present invention is a seat. The seat is attached to a swiveling platform. The platform rests inside the elevated rails of a wheeled base. The wheeled base can connect to a stationary base suitable for use in a conventional bathtub to allow the patient to be easily transferred into and out of the bathtub on the sliding platform and seat.

The seat, resting on a chair frame or a swiveling platform, may be in the form of a toilet seat, making the chair suitable for use as a support for use in a conventional toilet. Additionally, a commode may be attached to the seat to accommodate patients for whom the use of a conventional toilet is impractical.

### BRIEF DESCRIPTION OF THE DRAWINGS

FIG. 1 shows a chair attached to a movable platform resting in a wheeled base according to an exemplary embodiment of the present invention.

FIG. 2 shows a chair with the base portion being constructed so that the platform resting in it is elevated according to an exemplary embodiment of the present invention.

FIG. 3 shows a chair on a wheeled base, with the base connected to a second, stationary base positioned within a shower stall according to an exemplary embodiment of the present invention.

FIG. 4 shows a chair on an elevated wheeled base connected to a second, stationary base positioned within a bathtub according to an exemplary embodiment of the present invention.

FIG. 5 shows a sliding, swiveling platform resting in a wheeled base, connectable to a stationary base by a third bridge piece according to an exemplary embodiment of the present invention.

### DETAILED DESCRIPTION OF THE INVENTION

The present invention provides a swiveling seat mounted along a slidable platform such that it can be easily moved between a wheeled base that allows easy transfer of patients with limited mobility and a stationary base suitable for use in a shower or bathtub. The present invention provides the benefits presented by conventional devices without suffering from the drawbacks and limitations of such devices.

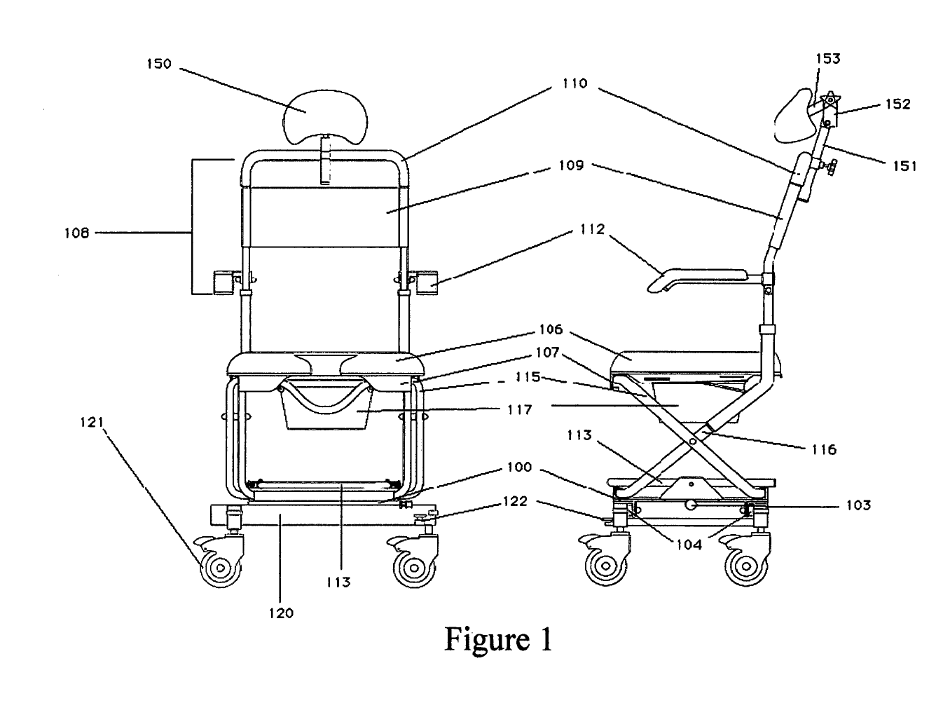

FIG. 1 illustrates an exemplary embodiment of the present invention. A chair frame is attached to a platform 100, with a seat 106 attached to the frame above the platform. The chair rests on a wheeled base 120. Rail wheels 104 join the chair platform 100 and fit within a track acting as a guide along which the wheels can slide and be held securely in place and level. These guides may be manufactured by multiple methods, including but not limited to extrusion, injection molding or welding, all of which are designed to reduce cost, increase production rates and help to embody features by virtue of the process used. All materials used should be corrosion resistant, such as aluminum, plastic, reinforced plastics, composites like carbon fiber, stainless steels and the like. The material used plays an important role in promoting durability, and is typically lightweight to make fabrication easier where possible. The extrusion design embodies not only a suitable track to allow wheels to move freely, but also provides a mechanical structure to support the user (up to, for example, 600 lbs or more), and also to keep the wheels 104 securely held or “trapped” inside the tracks.

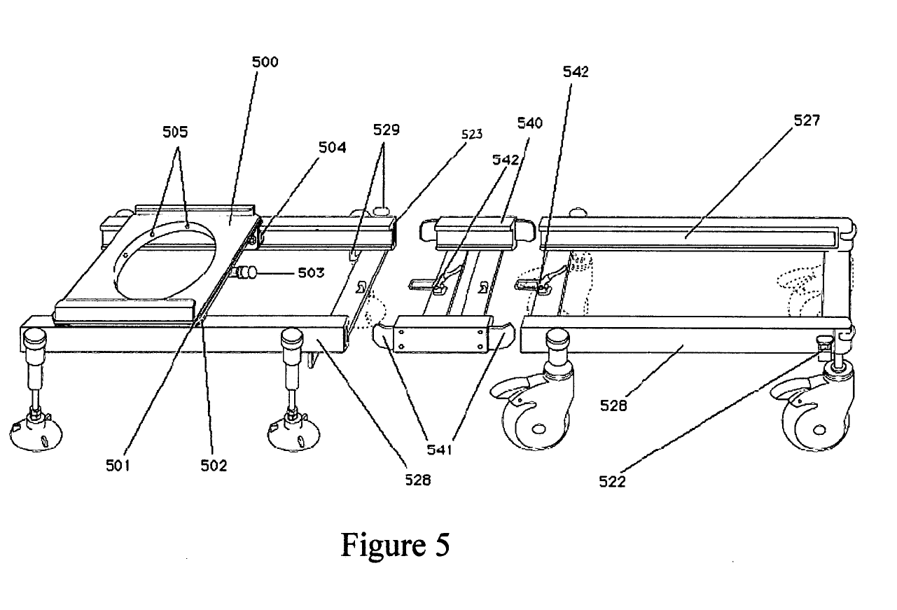

In the exemplary embodiment shown in FIG. 1 with further detail shown in FIG. 5, the platform 100 includes one TEFLON sheet sandwiched between two aluminum plates, such that the upper aluminum plate 501, upon which the chair rests, can rotate freely. Such materials used are merely exemplary and other suitable materials may also be used for the plates or sheet. The center of all three layers is cut out allowing free flow of water and weight reduction. The top plate 501 has a rim 505 which protrudes through the TEFLON and lower plate 502 to act as a guide for rotation. The TEFLON layer may also include a rim of slightly wider diameter than the rim of the top plate to assist smooth rotation. The top plate rim 505 includes fasteners to restrict the top plate 501 from lifting independently from the lower layers. Optionally, other embodiments may include alternative bearing assisted rotation systems, including TEFLON balls on which the chair platform 100 rests contained within a circular guide. Another embodiment may include horizontal pins with TEFLON wheels protruding from the rim of the top plate upon which all weight from the chair rests and pivots. A locking mechanism, for example spring loaded 122, allows the platform 100 to be secured to the wheeled base unit 120 to prevent unwanted sliding. A second locking mechanism 529 automatically engages when the chair is slid into the shower or bath portion of guides, thus ensuring the chair remains within the balanced limits of operation. A third locking mechanism, preferably spring loaded 103, is attached to the platform itself and holds the upper plate 501 of the platform in place to prevent unwanted swiveling. This pivoting lock 103 can secure the chair at different angles of rotation.

The frame of the chair may be detachable from the platform and collapsible for ease in storage and transport. Full assembly may be completed without use of tools, preferably by interlocking and snapping parts together. In the exemplary embodiment illustrated, multiple supports form the lower portion of the frame, holding the seat 106 above the platform 100. A first chair support 115, a frame in the shape of a closed rectangle, extends from the front of the chair's seat 106, where it is secured to the seat 106 by a downward and inward front extension 107, to the back of the platform 100. In some embodiments, the upper portion of the rectangular support 115 may curve downward at the center, as illustrated, to allow for improved access to the users body during showering. A second rectangular frame support 116 extends from the front of the platform 100 to the back of the seat 106 and preferably includes a section of thicker tubing allowing the chair sufficient weight bearing capacity without requiring structural support from the arm rests. The sides of the second frame support 116 may extend past the rectangular portion at an angle, such that they extend up and above the plane of the seat 106. An upper portion 108 of the frame may connect to these extensions. The platform 100 extends upward and inward at its front and back, forming guides into which the bottom portion of the rectangular supports fits securely. When detached from the seat 106 and from the housing in the platform 100, the rectangular frames, which are pivotingly connected (by, for example, a bolt connecting the corresponding sides of the frames), of the chair can be folded for storage. When attached to the seat and the platform, however, the frame is held firmly upright. Other embodiments may include adjustable seat height by, for example, a hydraulic mechanism. Such features would allow the user to be easily transferred on and off the chair. It would also allow the user to customize seat height optimizing knee bend caused by its relativity to the footrest height.

The frame of the chair may be manufactured from any suitable material. In exemplary embodiments, the chair is made of a lightweight, durable, and rust-resistant material such as, for example, aluminum, stainless steel, plastic, and composite materials.

In certain exemplary embodiments, the chair frame may have an upper portion 108 that extends above the seat. In certainly exemplary embodiments, this upper portion 108 is detachable from the frame's lower portion. The upper portion 108 may connect directly into the lower portion of the frame, as shown, or it may connect into a piece capable of pivoting with respect to the lower portion of the frame such that the chair can be adjusted to a reclining position or folded forward for storage.

The chair may include a backrest 109 for support. In certain exemplary embodiments, the backrest 109 includes a strip of anti-bacterial material stretched between the two sides of the upper frame 108. This allows greater accessibility during bathing. The backrest 109 may be permanently connected into the frame 108 or may loop snugly around the frame. The loops may be sewn or otherwise permanently fastened with, for example, clasps, buttons, or a fastening product such as VELCRO so that they can be unhooked and the backrest easily removed. The support may be made of nylon mesh, vinyl, canvas, or any other suitable material. In other embodiments, the backrest may be a solid, rigid assembly (made, for example, of plastic) with or without slats or holes, attached permanently or detachably to the upper portion of the frame.

The top, horizontal portion of the chair's upper frame may be covered with a layer of foam to form a padded hand grip 110 for use by the caretaker in moving the chair. The backrest frame may also support a headrest 150. In exemplary embodiments, this headrest is adjustable horizontally along the length of the backrest frame and can be adjusted vertically as well for comfort and size. The headrests adjustability is afforded by a lower bar 151 that can be set at any vertical height, a medial piece 152 that allows the headrest to tilt back wards and forwards, and a third piece 153 protruding from the headrest allowing for fine tuning of support angle. This design eliminates the need for an adjustable horizontal bar as seen on conventional devices which may cause a safety issue.

The chair may also include armrests 112. In certain exemplary embodiments, the armrests 112 are padded for comfort. In some embodiments, the armrests 112 may be detachable from the frame of the chair. In yet other embodiments, the armrests 112 may be pivotally connected to the chair, so that they can be lifted up to allow for easier entry to and exit from the chair seat.

As illustrated, some embodiments may also include a footrest 113. In exemplary embodiments, this footrest 113 is retractable, adjustable, and detachable. The illustration shows the footrest 113 in its retracted position. One or more straps (not shown) for support or restraint may be attached to the chair, including, for example 2- and 4-point connections between chest and waist, lap, foot and shin support straps. These may be attached to secure the patient at the backrest 109, seat 106, or footrest 113, as needed.

The chair seat 106 has a central aperture or opening comparable to that of a toilet seat. The chair has a range of soft seats shaped specifically for the users' width and is cushioned for comfort. In other embodiments, a removable cushion designed in the same shape as the seat may attach to or rest on the seat 106. In these embodiments, the seat may also be capable of supporting a cushion without an aperture. Other exemplary embodiments may allow the user to self assist bowel movements through digital stimulation by either front, sides or back. This requires the seat plate and commode positioning to have, for example, a minimum of 4″ clearance with the commode in position.

A commode 117 may attach to the bottom portion of the seat 106. The commode 117 may include a lid which can be used while the patient is seated in the chair as well as to assist in removal. The commode 117 may also include a handle to aid in removal. The commode 117 may be made of any conventional material for making waste receptacles used in the art, so long as it is rigid and can be easily sanitized. Alternatively, a disposable liner may be placed within the commode 117.

In the illustrated embodiment, the sides of the commode 117 contain rigid projections which are inserted into a slotted extension of the seat 106. However, any technique of attaching the commode 117 to the chair that is commonly used in the art may also be used. In another embodiment, for instance, a support tray may be located between the seat 106 and the platform 100. The support tray, which may be detachable in some embodiments, is constructed to hold a removable commode. The tray may be open in its construction (a wire frame, for example) or it may be solid.

The base 120 on which the platform rests may include two or more parallel rails joined by one or more transverse supports. The rails are supported above the ground on two or more sets of casters 121. The casters 121 should be of such a size such that they can support and stabilize the chair with the weight of a patient seated in it and that the lower plane of the rails can clear the lip on a standard shower. The caster fittings and wheels may be constructed of materials commonly used in the art. For example, the fittings may be made of steel or any other suitable metal, and the wheels may be made of stainless steel, polyurethane, plastic, nylon, rubber, or any combination thereof. In exemplary embodiments, a swivel caster with a braking mechanism is used. However, fixed casters could also be used. The casters 121 attach to the rails of the base 120. In exemplary embodiments, the casters 121 snap into ring- or tube-like extensions of the outer surface of the rails such that the casters do not interfere with the sliding motion of the platform 100, provide maximum stability, and can be easily attached and detached for transport and storage. Specific attention to leg and chair heights allow 5″ or greater casters to be used while maintaining a chair platform height under 25″. Another embodiment may allow for the user to transport, transfer and bathe unassisted. This may require a lower seat height, mechanized wheeled base or arm powered wheels for movement.

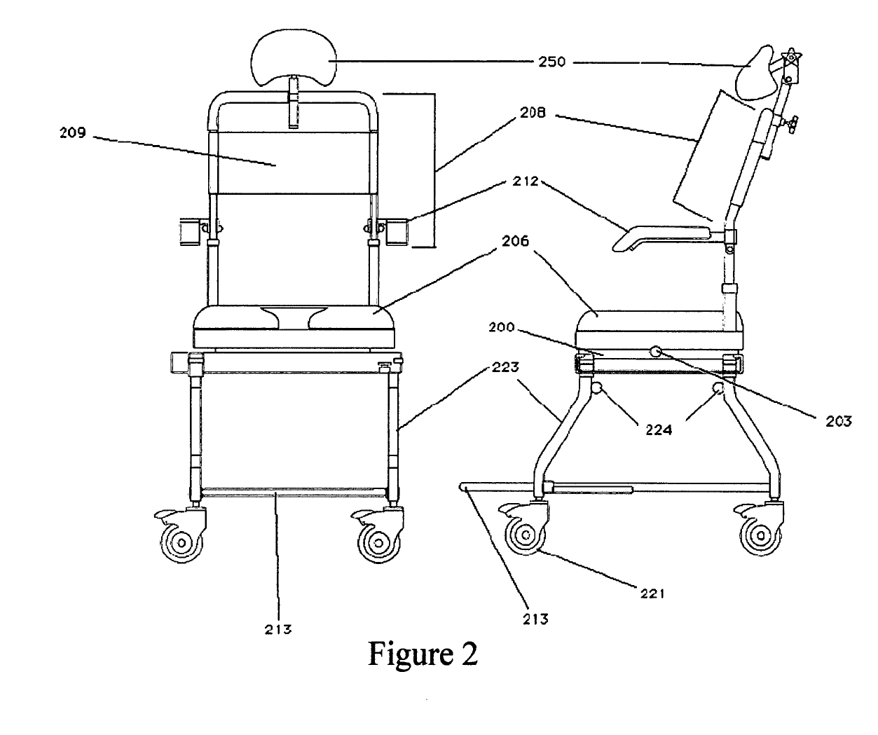

FIG. 2 shows another exemplary embodiment of the invention, in which a chair is formed by a seat 206 resting directly on a platform 200. The upper portion 208 of the chair in this embodiment is similar to the upper portion of the chair as described in FIG. 1. The upper portion 208 may include fixed or pivoting armrests 212 that are permanently joined to or detachable from the frame. The upper portion may include a backrest 209 as described above. The upper portion includes a detachable headrest 250 as described above.

The seat 206 rests directly on the platform. In some embodiments, the seat 206 contains aperture similar to that of a toilet seat, while in other embodiments it is solid. The seat 206 may be padded for comfort or may support a cushion with the same shape. Exemplary embodiments allow the seat opening to be positioned at the angle of the users' choosing for digital stimulation.

The platform 200 includes one TEFLON sheet sandwiched between 2 aluminum plates, such that the upper aluminum plate 501, upon which the chair rests, can rotate freely. Such materials used are merely exemplary and other suitable materials may also be used for the plates or sheet. The center of all three layers is cut out allowing free flow of water and weight reduction. The top plate 501 has an attached rim 505 which protrudes through the TEFLON and lower plate 502 to act as a guide for rotation. The TEFLON layer may also include a rim of slighter wider diameter than the rim of the top plate to assist smooth rotation. The top plate rim includes fasteners to restrict the top plate from lifting independently from the lower layers. Exemplary embodiments include alternative bearing assisted rotation systems including TEFLON balls on which the chair platform rests contained within a circular guide. Another embodiment could include horizontal pins with TEFLON wheels protruding from the rim of the top plate upon which all weight from the chair rests and pivots. The platform 200 rests inside a wheeled base. A commode may also be added to seat 206.

The wheeled base may include one or more parallel rails joined together by one or more transverse supports. Each rail is attached to two supportive legs 223 which extend downward and terminate in casters 221. The legs 223 may be connected by a cross-piece 224 for support. The legs 223 may extend both downward and outward, as illustrated, to provide a broader base of support. A footrest 213 may attach to the legs 223 or rails between the legs and extend forward in front of them.

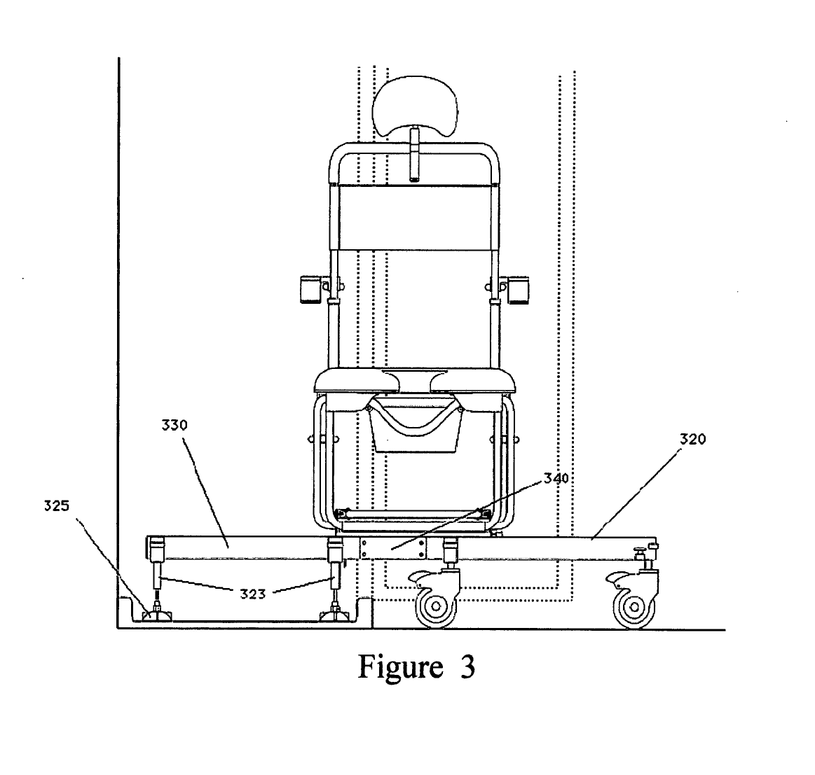

FIG. 3 shows the wheeled transfer base 320 of the chair shown in FIG. 1 attached to a stationary base 330 positioned in a shower stall. In the exemplary embodiment depicted, the stationary base 330 includes two parallel rails connected by transverse supports. The rails contain guides through which the rail wheels of the platform can slide. The stationary base 330 rests on four legs 323, which in exemplary embodiments snap into ring- or tube-like extensions from the base's rails in such a way that they are easily assembled and disassembled but do not interfere with the sliding of the platform. In exemplary embodiments, the legs end in suction cups 325 to secure the base inside the shower. The legs 323 are of a sufficient height to clear the lip of a standard shower stall. The legs 323 may also be adjustable in height, to allow greater clearance when needed and to decrease the height of the stationary base 320 for more convenient storage.

The chair can slide from the wheeled base 320 to the stationary base 330. The two bases may directly connect, or a bridge piece 340 may be used. Other embodiments of the bridge may intuitively lock together on contact and disconnect through the push of a spring loaded button. This will enable the user to perform more of the bathing process unassisted. Once on the stationary base 330, a spring engaged interference pin 529 mechanically prevents the platform from sliding beyond safe limits for balance and retaining the platform on the track independent of the bridge connector's 340 absence. The wheeled base 320 and any connecting pieces can then be removed to allow the shower door to close.

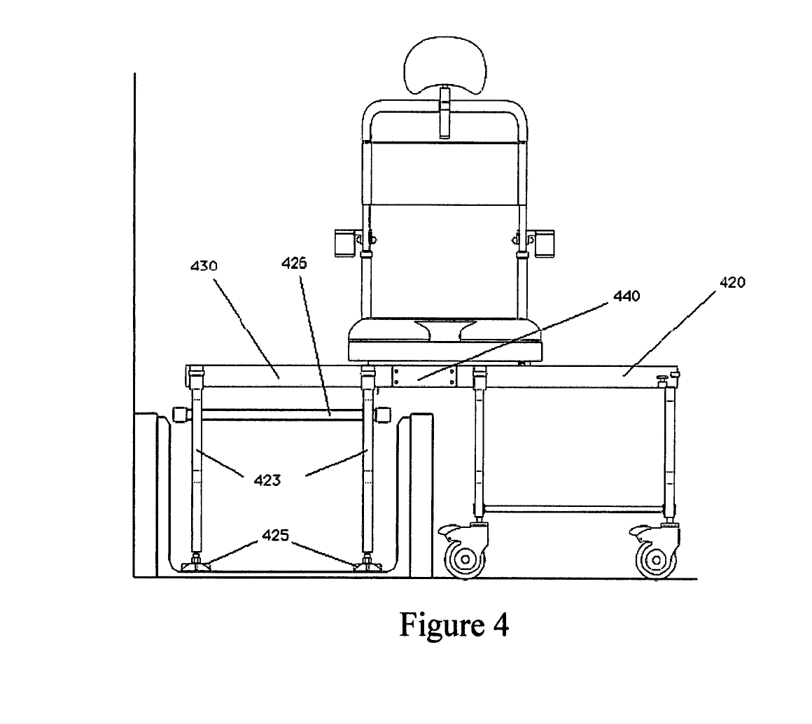

FIG. 4 shows an alternate embodiment of the platform, chair, and connecting bases. In this illustration, the assembly illustrated in FIG. 2 is connected to a stationary base 430 placed inside a conventional bathtub. The bases may connect directly or connect using a bridge piece 440. The base consists of two or more parallel rails, each supported by two or more legs 423. The rails contain guides through which the platform can slide when the two bases are connected. The legs 423 may be connected to the rails by way of ring- or tube-like extensions on the outer rails, and should be long enough that the platform sits above the rim of the bathtub.

In exemplary embodiments, the legs 423 end in suction cups 425 to keep the device stationary within the bathtub. Two or more adjustable crosspieces 426 run horizontally between the legs in some embodiments to provide stability and prevent lateral movement of the base. The ends of the crosspiece 426 may be covered with a coating or cap (made of, for instance, rubber, plastic, or foam) to prevent damage to the surface of the bathtub or suction cups 425.

FIG. 5 shows a sliding platform 500 resting inside a wheeled base 520. The platform 500 is includes two separate plates, joined through the center so that the top plate 501 can pivot freely while the bottom plate 502 remains stationary. In the exemplary embodiment illustrated, a large ring forms a central aperture that extends through both plates. The aperture allows for drainage of water off of the platform when the chair is used for bathing. It also allows for attachment of a commode in embodiments where the seat rests directly on the platform.

The upper plate 501 pivots freely around the ring. In the exemplary embodiments, the ring is affixed to the upper plate 501 and can pivot inside the aperture of the lower plate 502. In order to reduce friction, the ring, the plates, or portions thereof may be coated or spaced by an appropriate layer. Any coating commonly used for reducing friction may be used, but exemplary embodiments use a molded sheet of high molecule plastic or similar substance, such as TEFLON. The ring contains a series of small holes at evenly spaced intervals. The pivoting lock 503 works by projecting itself through the ring by means of one of these holes, preventing the ring from turning. When the lock is manually retracted, the platform can pivot freely. Multiple holes allow the ring to be secured at different angles of rotation. The bases are constructed of parallel rails 528 along which the platform can glide. Any mechanism allowing the platform 500 to move smoothly along the rails 528 may be used. For example, the platform 500 could contain guides on its lower surface into which the rails fit, so that, with or without the aid of such additional devices as are commonly used to reduce friction, the platform can move along the upper surface of the rails.

In the embodiment illustrated in FIG. 5, rail wheels 504 are attached to the platform 500. These rail wheels 504 are spaced and sized to fit into guides 527 which run along the length of the bases' rails 528. The rail wheels 504 may be made of any material conventionally used in the art, such as, for example, stainless steel, polyurethane, plastic, nylon, composite materials or rubber.

In the exemplary embodiment illustrated, the rail wheels 504 are attached to extensions from the bottom of the platform 500, with the wheel axis parallel to the platform 500. The rail wheels fit inside the rail guides 527 and the plane of the platform 500 sits on or just above the top of the rails 528. Alternately, the rail wheels may be attached to the sides of the lower plate 502 of the platform 500, so that the plate 502 sits between the base rails 528 on the same plane as the rail guides 527 and the upper plate 501 is suspended just above the rails. FIG. 5 shows an exemplary embodiment wherein the guides 527 are on the interior surface of the parallel rails 528. In other embodiments, including embodiments where the platform slides along a single center beam, the guides 527 through which the rail wheels 504 glide may face outward, with the rail wheels 504 correspondingly turned to face the center of the platform 500.

The rails of the base are connectable to a bridge piece 540, which is in turn connected to a stationary base. The rails 528 on each base and on the bridge piece contain corresponding guides 527, so that the rail wheels 504 of the platform 500 can slide continuously along the assembly when the bases are connected. In the illustrated embodiment, projections 541 on the bridge piece are inserted into corresponding slots 535 in the base rails behind the rail guides 527 to connect the bases. However, any alternate way of connecting the rails 528 so that the guides 527 are aligned may be used. Though bases designed for use in a shower are shown, elevated bases suitable for use in a bathtub, like those shown in FIG. 4, may be connected in an identical way. The bridge piece 540 is present in exemplary embodiments, as it allows the connection of the two bases over the edge of a shower or bathtub without adding an unwieldy extension on the front of the transfer chair and while still allowing the shower or bath door to be closed with the base inside. However, in alternate embodiments, the wheeled base may connect directly to the stationary base without the aid of the bridge.

Latches 542 secure the bridge rail to the wheeled and stationary bases for transfer of the platform between the two bases. Any appropriate method for securing the connected bases, such as a sliding bolt, a pull-pin, or a snap assembly, may be used in place of the latch.

When the wheeled base has been connected (with or without the aid of a bridge piece) to the stationary base and secured, the platform 500 can slide from the wheeled base to the stationary base sitting in a shower or bathtub. A side safety latch 529 on the rails of the stationary base prevents the platform from unwanted sliding without hindering the pivoting motion of the platform. Preferably a spring engaged interference pin may be used to mechanically prevent the wheels from sliding. The user depresses side safety latch 529, thus lowering the mechanical interference pin so that the wheels can roll along in the channel, track, or groove. The wheeled base and the bridge piece can then be detached from the stationary base to allow a shower door to be closed or a shower curtain to be drawn.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An assist device, the device comprising:
a seat platform mounted on a swiveling platform which slides along one or more rails between two or more connecting bases.

2. The device of claim 1, wherein the platform comprises two plates with central apertures with one ring forming the inner surface of both apertures such that each plate can pivot around the ring with respect to each other.

3. The device of claim 2, further comprising a bearing mechanism or minimal friction layer to assist in motion.

4. The device of claim 2, wherein the plates are coated to reduce friction.

5. The device of claim 2, wherein the plates are spaced by a minimal friction layer or bearing based system.

6. The device of claim 1, wherein at least one of the bases has wheels.

7. The device of claim 1, further comprising a backrest.

8. The device of claim 1, further comprising armrests.

9. The device of claim 8, where the armrests pivot with respect to the frame and allow a clear path for transfers from the side.

10. The device of claim 8, wherein the armrests are removable.

11. The device of claim 1, wherein the seat is in the shape of a toilet seat and can be turned to suit the users preference.

12. The device of claim 1, wherein the chair is fitted with a commode.

13. The device of claim 12, wherein the commode is removable.

14. The device of claim 1, wherein the chair frame is detachable from the platform.

15. The device of claim 1, wherein the chair frame folds or assembles and disassembles without tools.

16. A chair assembly, the assembly comprising:
a chair frame with a seat mounted on a swiveling platform, which can slide along one or more rails between two or more connecting bases wherein one of the bases is adapted for placement in a shower.

17. The assembly of claim 16, wherein the platform comprises of two plates with central apertures with one ring forming the inner surface of both apertures such that one plate can pivot around the ring with respect to each other.

18. The assembly of claim 16, wherein the seat is in the shape of a toilet seat which can be rotated to suit the suers preference.

19. The assembly of claim 16, wherein the chair frame is detachable from the platform.

20. A chair assembly, the assembly comprising:
a seat mounted on a swiveling platform, which slides between two or more connecting bases wherein one of the bases is adapted for placement in a bathtub
